(19) United States
(12) Patent Application Publication
(10) Pub. No.: US 2012/0082494 A1
(43) Pub. Date: Apr. 5, 2012

(54) CLEANING DEVICE, CLEANING METHOD AND IMAGE FORMING APPARATUS

(75) Inventor: Noboru Furuyama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/233,241

(22) Filed: Sep. 15, 2011

Related U.S. Application Data
(60) Provisional application No. 61/389,893, filed on Oct. 5, 2010.

(51) Int. Cl. G03G 21/00

(52) U.S. Cl. 399/350

(57) ABSTRACT

According to one embodiment, a cleaning device which is used in an electrophotography-type image forming apparatus includes a blade which removes toner remaining on a surface of a photoconductor, and a linear pressure of the blade with respect to the surface of the photoconductor and a value χ of rebound resilience of a material of the blade at a temperature of 23° C. satisfy a relationship shown in the expression below.

5.0×10⁻⁴×χ²−9.8×10⁻³×χ+1.52≦linear pressure≦2.0

### CROSS-REFERENCE TO RELATED APPLICATIONS

This application is based upon and claims the benefit of U.S. Provisional Application No. 61/389,893, filed on Oct. 5, 2010; the entire contents of which are incorporated herein by reference.

### FIELD

Embodiments described herein relate generally to a cleaning device, a cleaning method, and an image forming apparatus.

### BACKGROUND

In an electrophotography-type image forming apparatus (Multi-Functional Periphery), a method is widely used, in which a visible image obtained by developing a latent image by using toner, which is formed on a photoconductor that is an image carrier, is transferred to a medium (a sheet or a resin sheet), and a visualizing material of the visual image is fixed to the medium, using heat melting.

The image forming apparatus includes a cleaning mechanism which cleans toner remaining on the photoconductor without being transferred to the medium. When toner which is manufactured using a chemical method is used, instead of toner manufactured using a milling method in the related art, it is not easy to clean the residual toner on a surface of the photoconductor, and a cleaning failure occurs.

### BRIEF DESCRIPTION OF THE DRAWINGS

FIG. 1 is an exemplary diagram for showing a configuration of an image forming apparatus, according to an embodiment.

FIG. 2 is an exemplary partially enlarged diagram of the image forming apparatus, according to the embodiment.

FIG. 3 is an exemplary diagram which schematically shows a configuration of a cleaning device, according to the embodiment.

FIG. 4 is an exemplary diagram which shows a cleaning performance for each toner, according to the embodiment.

FIG. 5 is an exemplary diagram which shows a relationship between a value of the rebound resilience of a cleaning blade and a lower limit linear pressure for cleaning, according to the embodiment.

FIG. 6 is an exemplary diagram which shows a relationship between a toner circularity and a lower limit linear pressure for cleaning, according to the embodiment.

FIG. 7 is an exemplary diagram which shows a relationship between a value of 300% modulus and an edge abrasion loss after long-term use, according to the embodiment.

FIG. 8 is an exemplary diagram for describing the edge abrasion loss, according to the embodiment.

FIG. 9 is an exemplary diagram which shows a relationship between the edge abrasion loss and the lower limit linear pressure for cleaning, according to the embodiment.

FIG. 10 is an exemplary flow chart which shows a procedure for obtaining conditions configured in the cleaning device, according to the embodiment.

### DETAILED DESCRIPTION

In general, according to one embodiment, the cleaning device which is adopted in the electrophotography-type image forming apparatus, includes a blade which removes toner remaining on the surface of the photoconductor. In the cleaning device, a linear pressure with respect to the surface of the photoconductor of the blade and a value χ of rebound resilience satisfy a relationship in an expression below;

5.0×10⁻⁴×χ²−9.8×10⁻³×χ+1.52≦linear pressure≦2.0

Hereinafter, the embodiments of the invention will be described.

### First Embodiment

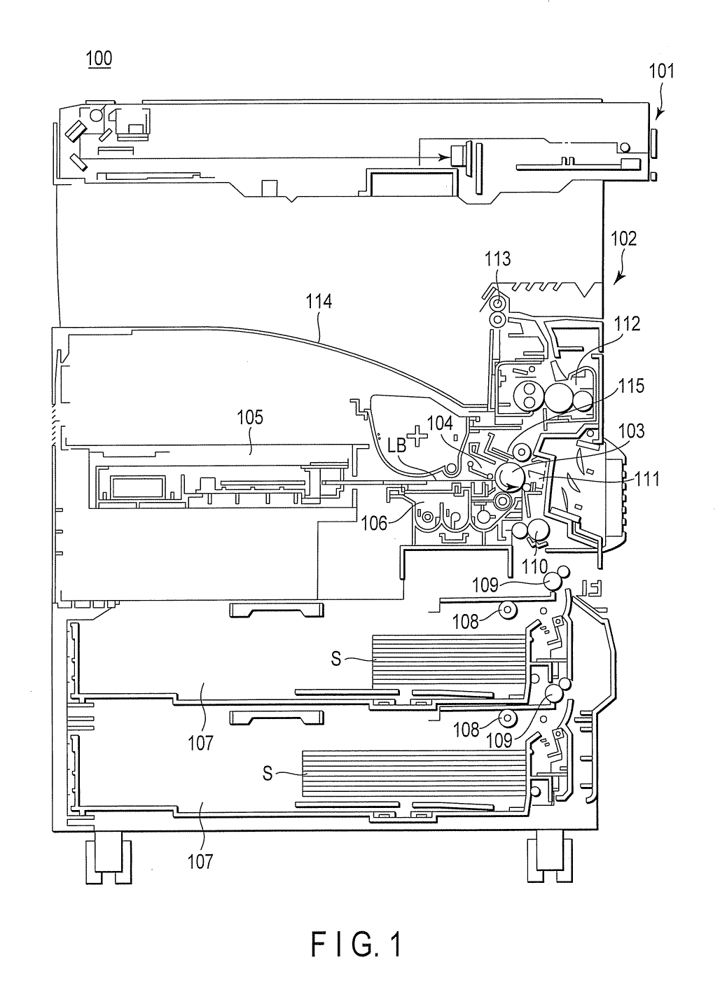

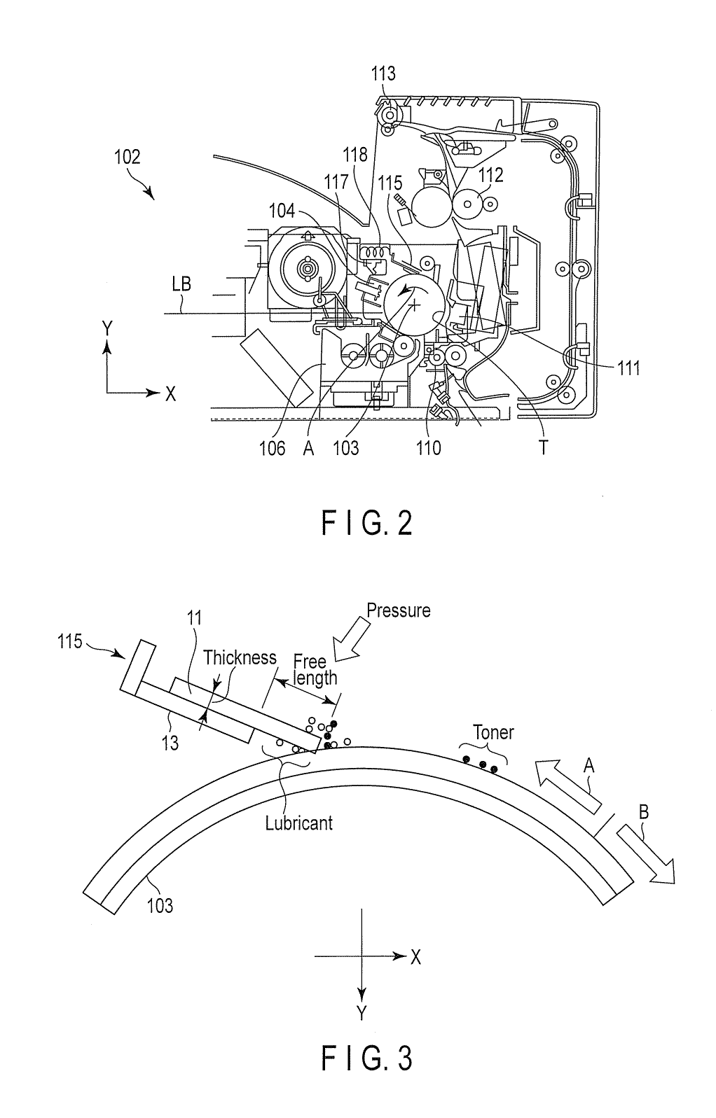

FIG. 1 is an exemplary diagram which shows a configuration of an image forming apparatus according to the embodiment of the invention. FIG. 2 is an exemplary partially enlarged diagram of the image forming apparatus in the embodiment of the invention. A configuration and operation of the image forming apparatus will be described while referring to FIGS. 1 and 2.

The image forming apparatus 100 includes a scanner unit 101 and an image forming unit 102. The scanner unit 101 generates an image signal by reading image information of an original document. The image forming unit 102 forms an image, on the basis of an image signal which is output from the scanner unit 101, or an image signal which is provided from outside.

The image forming unit 102 includes a photoconductor 103, a charger 104, an exposure device 105, a developing device 106, a sheet cassette 107, a pickup roller 108, a conveying roller 109, an aligning roller 110, a transfer device 111, a fixing device 112, a sheet discharging roller 113, a discharge tray 114, a cleaning device 115, a separating device 116, and a neutralizing device 117.

The photoconductor 103 has a photoconductive layer, for example, on the periphery of a hollow cylinder. When the photoconductive layer is irradiated with light in a state of being applied with a predetermined potential thereon, the potential on an irradiated area is changed, and the change of the potential is maintained as an electrostatic image. The photoconductor 103 rotates at a predetermined speed, in a direction of counterclockwise with an arrow A. The photoconductor 103 may have a belt shape, in addition to a drum shape. It is needless to say that the photoconductor may be used in an image forming apparatus which adopts an intermediate transfer body, or the like.

The charger 104 charges a surface of the photoconductor 103 with a predetermined polarity and to a predetermined potential. The exposure device 105 irradiates the photoconductive layer of the photoconductor 103 with a laser beam LB in which optical intensity is changed according to an image signal supplied from the scanner unit 101. The electrostatic image (a latent image) is formed on the photoconductive layer of the surface of the photoconductor 103 when a charging surface of the photoconductor 103 is exposed by the laser beam LB from the exposure device 105.

The developing device 106 accommodates a two-component developer which is formed of a carrier and toner, and supplies the developer to the surface of the photoconductor 103. In this manner, the latent image which is maintained on the photoconductive layer of the surface of the photoconductor 103, is visualized, thereby forming a toner image. In addition, the developer may be a single component developer which is formed only of toner.

The sheet cassette 107 accommodates a sheet S (a sheet medium). The sheet S in the sheet cassette 107 is supplied to the aligning roller 110, using the pickup roller 108 and the conveying roller 109. The sheet S is guided at predetermined timing to a transfer position T where the photoconductor 103 and the transfer device 111 face.

The transfer device 111 applies a predetermined potential to the sheet S at the transfer position T, and transfers the toner image on the photoconductor 103 to the sheet S. The separating device 116 applies a DC voltage which has the same polarity as that of the toner, or a separating voltage in which DC voltage with a predetermined polarity is overlapped with AC voltage, to the sheet S holding the toner image, thereby separating the sheet S from the photoconductor 103.

The fixing device 112 heats and pressurizes the sheet S on which the toner image which is separated from the photoconductor 103, is maintained, and fixes the melted toner image to the sheet S. The sheet discharging roller 113 conveys the sheet S on which the toner image is fixed by the fixing device 112, to the discharge tray 114.

The cleaning device 115 collects the toner, or the like, attached to the surface of the photoconductor 103. That is, the toner (residual toner) remaining on the surface of the photoconductor 103, is forcibly raked out, using the cleaning device 115.

The neutralizing device 117 includes, for example, an LED which outputs a red light, and returns a potential which remains on the photoconductive layer of the photoconductor 103, to an initial stage, by irradiating the photoconductive layer with the red light (neutralizing).

FIG. 3 is an exemplary diagram which schematically shows a configuration of the cleaning device, according to the embodiment of the invention.

The cleaning device 115 includes a cleaning blade 11 which comes into contact with the photoconductive layer of the photoconductor 103 with a predetermined pressure. The cleaning blade 11 is fixed to a base plate 13. The front end of the cleaning blade 11 comes into contact with the photoconductive layer on the surface of the photoconductor 103 in a state of facing a direction of an arrow B which is the counter direction to the rotation direction (a direction of an arrow A) of the photoconductor 103, when the base plate 13 is supported at a fulcrum which is preset in a case (housing) of the cleaning device 115.

In addition, a pressure is applied to the base plate 13 which supports the cleaning blade 11, by a spring or a pressurizing mechanism 118. The front end of the cleaning blade 11 comes into contact with the photoconductive layer on the surface of the photoconductor 103 with a predetermined pressure, using the pressure. In addition, the front end of the cleaning blade may be pressed to the surface of the photoconductor with a predetermined pressure, by using the elasticity or bending of the cleaning blade, and an attaching position of the cleaning blade, without using the spring.

Subsequently, a cleaning failure will be described, when toner which is manufactured using a chemical method is used, instead of toner manufactured by a milling method in the related art.

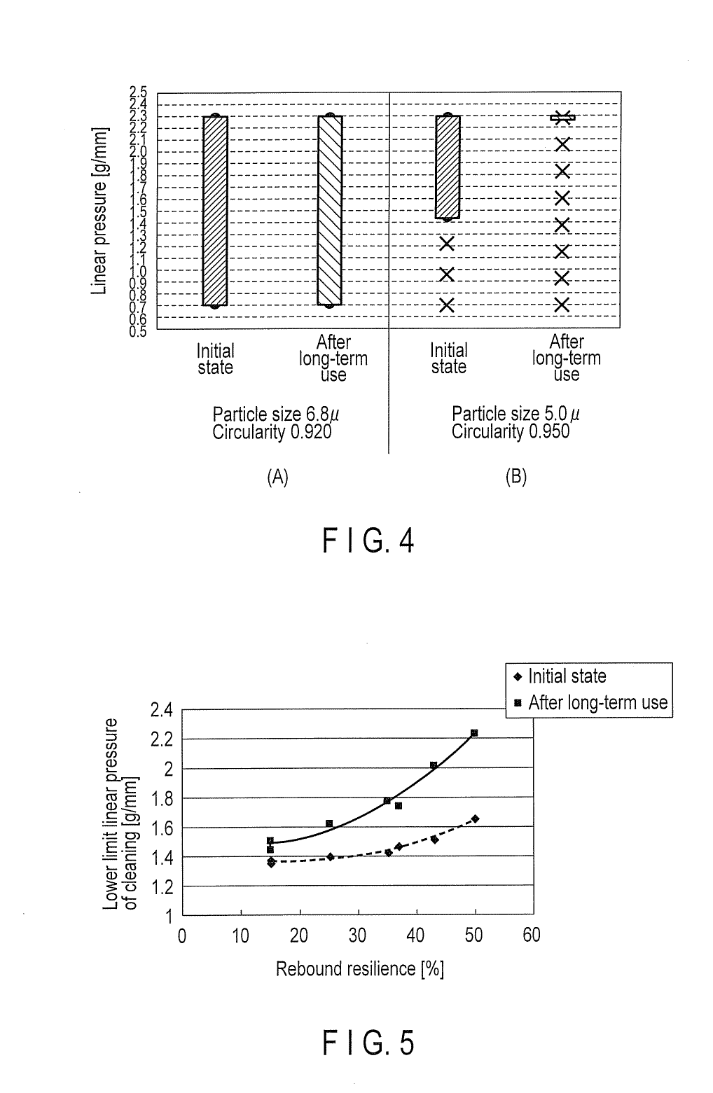

FIG. 4 is an exemplary diagram which shows a cleaning performance for each toner according to the embodiment of the invention. FIG. 4A shows a cleaning performance when the toner manufactured by a milling method in the related art is used. FIG. 4B shows a cleaning performance when the toner manufactured by the chemical method is used.

The toner which is manufactured by the milling method in the related art has a particle size of 6.8 μl and a circularity of 0.920. On the other hand, the toner which is manufactured by the chemical method has a particle size of 5.0 μm and a circularity of 0.950. It is understood from the property of the toner that the toner manufactured by the chemical method has a smaller particle size than the toner in the related art, and has a shape which is circular or nearly spherical.

The vertical axis of the coordinates shown in FIG. 4 represents a linear pressure (g/mm) of the cleaning blade 11. The “initial stage” on the horizontal axis represents a case where the cleaning blade 11 in the initial stage was used. The “after long-term use” on the horizontal axis represents a state in which the cleaning blade 11 was used up to the maximum number of uses which is prescribed in the image forming apparatus 100.

In addition, the linear pressure is a value in which a pressure which presses the cleaning blade 11 to the surface of the photoconductor 103 (a measured value) is divided by a blade length. Further, an x mark in the drawing means that there was a cleaning failure.

As shown in FIG. 4, the cleaning failure did not occur when the toner manufactured by the milling method in the related art, was used. However, the cleaning failure occurred from the initial state when the toner manufactured by the chemical method, was used. Further, the cleaning failure can be prevented by increasing the linear pressure of the cleaning blade 11. However, it is not easy to prevent the cleaning failure from occurring, in the cleaning blade 11 having a large number of uses, even when increasing the linear pressure.

The cleaning blade 11 repeats a minute vibration due to a stick-slip phenomenon on the surface of the photoconductor 103, thereby cleaning the toner on the photoconductor using the stick-slip phenomenon. However, when the chemical toner is used, since the toner has a different shape from the toner manufactured by the milling method in the related art, for example, has a nearly spherical shape and has a small particle size, the toner slips away even in the minute vibration of the stick-slip phenomenon.

Further, as is presumed from FIG. 4, an edge abrasion of the blade is one important factor which influences the cleaning performance of the blade. Since the cleaning performance deteriorates along with the edge abrasion of the blade, it is an important problem to be solved to suppress the edge abrasion of the blade, in order to maintain the cleaning performance over time.

That is, a countermeasure may be considered to decrease the minute vibration of the stick-slip phenomenon, in order to reduce the cleaning failure. However, as shown in FIG. 4, when increasing the linear pressure, the number of uses of the cleaning blade 11 decreases due to the edge abrasion of the blade. Accordingly, a countermeasure is needed with this point in mind.

Therefore, a measure for reducing the minute vibration of the stick-slip phenomenon was considered, by decreasing the value of the rebound resilience of the cleaning blade 11. The amplitude of the minute vibration is considered to be decreased, since the elasticity of the cleaning blade 11 decreases when the value of the rebound resilience is low.

FIG. 5 is an exemplary diagram which illustrates a relationship between the value of the rebound resilience of the cleaning blade and the lower limit linear pressure of cleaning, according to the embodiment of the invention. The property shown by a dotted line represents a case where the cleaning blade 11 in the initial state was used. The property shown by a solid line represents a case where the cleaning blade 11 was used up to the maximum number of uses which is prescribed in the image forming apparatus 100. In addition, the value of the rebound resilience used here, is a value of the rebound resilience at a temperature of 23° C.

It is understood from a result shown in FIG. 5 that the minute vibration of the stick-slip phenomenon decreases when the value of the rebound resilience is small, and it is possible to perform cleaning even under a low linear pressure. In addition, it is understood that an increase of the linear pressure accompanying the edge abrasion of the blade becomes small, when the value of the rebound resilience is small.

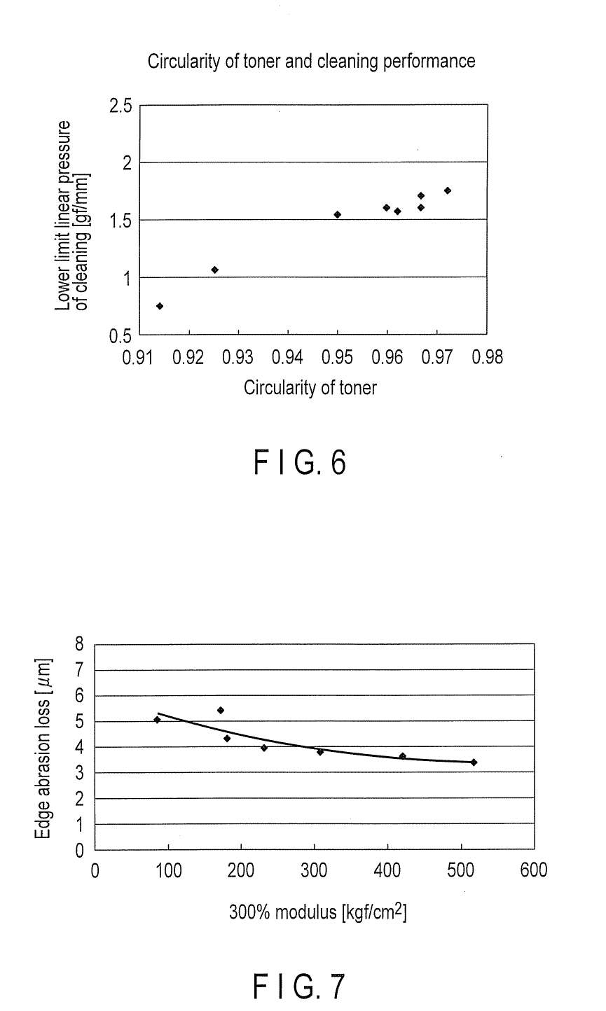

FIG. 6 is an exemplary diagram which illustrates a relationship between the circularity of the toner and the lower limit linear pressure of cleaning, according to the embodiment of the invention. The necessary lower limit linear pressure of cleaning is increased, as the circularity of the toner is nearly spherical. Accordingly, the circularity of the toner which is nearly spherical becomes a factor causing the cleaning failure.

Subsequently, as a physical property of the cleaning blade 11, a 300% modulus (Kgf/cm²) was selected. The 300% modulus is a value of a tensile stress which is necessary to extend a material of the cleaning blade to a length of 300% (3 times).

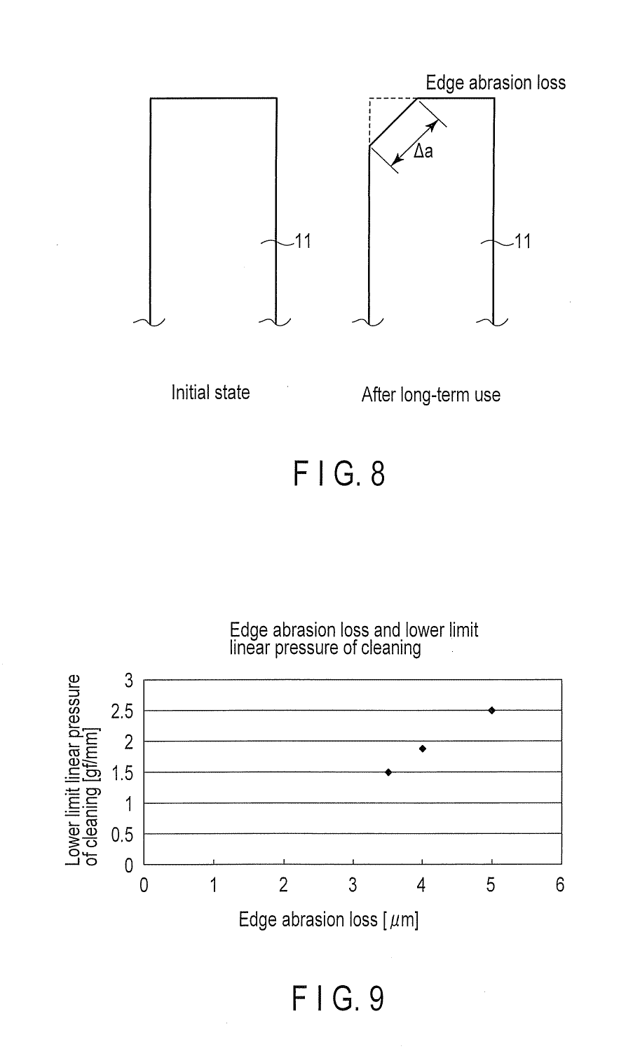

FIG. 7 is an exemplary diagram which illustrates a relationship between the value of the 300% modulus and the abrasion loss of the edge “after long-term use” according to the embodiment of the invention. Here, the edge abrasion loss is a value defined by Δa shown in FIG. 8.

As shown in FIG. 7, it is understood that the edge abrasion loss of the cleaning blade 11 decreases, as the value of the 300% modulus is high.

FIG. 9 is an exemplary diagram which illustrates a relationship between the abrasion loss of the edge and the lower limit linear pressure of cleaning, according to the embodiment of the invention.

The necessary lower limit linear pressure of cleaning increases, as the abrasion loss of the edge increases, accordingly it is necessary to set conditions in order to suppress the loss of edge abrasion.

On the basis of the above measured result, conditions configured in the cleaning device 115 when using the toner manufactured by the chemical method, will be described.

First, as shown in FIG. 5, it is necessary for the value of the lower limit linear pressure of cleaning to be present in the upper area of a characteristic curve shown in “after long-term use”, in order to prevent an occurrence of the cleaning failure “after long-term use”. Meanwhile, the lower limit linear pressure of cleaning needs to be 2.0 gf/mm or less. If the lower limit linear pressure of cleaning is larger than 2.0 gf/mm, inconveniences such as bending of the blade, a noise, or the like occur and the life of the blade is shortened due to an increase in the abrasion loss of the photoconductor.

The conditions are expressed in the following expression.

5.0×10⁻⁴×χ²−9.8×10⁻³×χ+1.52≦set linear pressure≦2.0 Expression (1)

Here, χ denotes a value of the rebound resilience at a temperature of 23° C.

In the left term of the inequality in the expression (1), the property of “after long-term use” in FIG. 5 is approximated to a quadratic expression, using the least squares method.

Subsequently, a specific example for obtaining conditions configured in the cleaning device 115 will be described.

When the property of the toner, specifically the circularity is determined, it is possible to obtain a lower limit linear pressure of cleaning to be set, with reference to FIG. 6. For example, when the circularity of the toner is 0.95, it is desirable to set the lower limit linear pressure of cleaning to be 1.5 gf/mm or more.

When the lower limit linear pressure of cleaning is determined, it is possible to obtain the value of the rebound resilience of the cleaning blade 11 at a temperature of 23° C., using the expression (1). For example, when the lower limit linear pressure of cleaning is set to be 2.0 gf/mm or less, the value of the rebound resilience of the cleaning blade at a temperature of 23° C. becomes 45% or less.

In addition, when the lower limit linear pressure of cleaning is determined, it is possible to obtain the abrasion loss of the edge, with reference to FIG. 9. For example, when the lower limit linear pressure of cleaning is set to 2.0 gf/mm, it is necessary to suppress the abrasion loss of the edge to 4 mm or less.

When the abrasion loss of the edge to be suppressed is obtained, it is possible to obtain the 300% modulus, with reference to FIG. 7. For example, when the abrasion loss of the edge is set to 4 mm or less, the 300% modulus is set to 300 kgf/cm² or more.

As described above, it is possible to obtain conditions configured in the cleaning device 115, on the basis of the circularity which is the property of the toner. However, it is not necessary for the conditions configured in the cleaning device 115, to follow the above-described procedure; however, it is desirable for the circularity, the lower limit linear pressure of cleaning, the rebound resilience, and the 300% modulus to satisfy the above-described relationship.

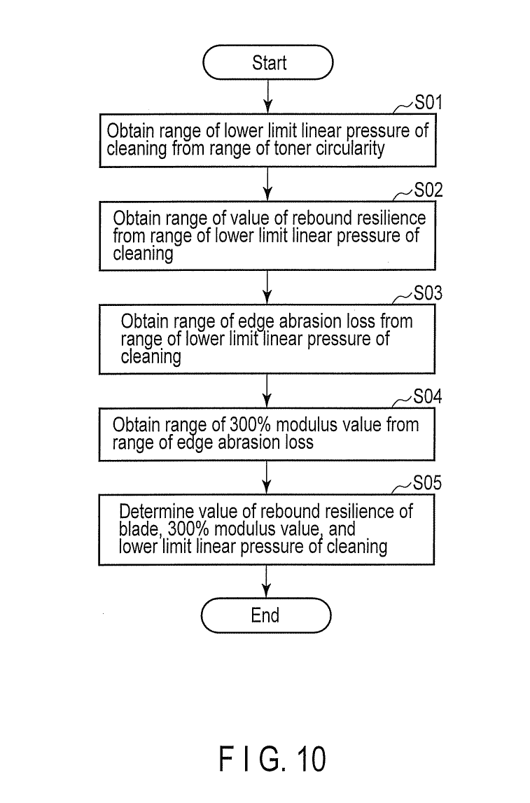

FIG. 10 is an exemplary flow chart which illustrates a procedure for obtaining conditions configured in the cleaning device 115, according to the embodiment of the invention. The flow chart may be automatically processed, or may be manually processed by the designer.

In Act 01, the range of the lower limit linear pressure of cleaning is obtained from the range of the circularity of the toner. In Act 02, the range of the value of the rebound resilience is obtained from the range of the lower limit linear pressure of cleaning.

In Act 03, the range of the edge abrasion loss is obtained from the range of the lower limit linear pressure of cleaning. In Act 04, the range of the value of the 300% modulus is obtained from the range of the edge abrasion loss. Further, in Act 05, the respective obtained values in the range of the lower limit linear pressure of cleaning, in the range of the rebound resilience, and in the range of the 300% modulus, are selected.

In addition, in order to perform the processing according to the above flow chart, it is necessary to quantitatively obtain the relationship between the circularity of the toner and the lower limit linear pressure of cleaning; the relationship between the lower limit linear pressure of cleaning and the value of the rebound resilience; the relationship between the lower limit linear pressure of cleaning and the edge abrasion loss; and the relationship between the edge abrasion loss and the value of the 300% modulus.

An example of the cleaning device 115 which is obtained by applying the above processing will be described.

Conditions of a cleaning device 115 of a photoconductor with φ30 of an image forming apparatus 100 in which toner with a volume average particle size of 5.0 μm and a circularity of 0.950, was used, were set. The diameter of the photoconductor 103 was φ30, and a processing speed was 200 mm/sec. The free length of a cleaning blade 11 was 9.5 mm, and the thickness thereof was 2.0 mm. The cleaning blade 11 is arranged to be counter with respect to the photoconductor 103, and a cleaning angle at the moment was set to 9.5 degrees. A physical property of the cleaning blade 11 had a value of the rebound resilience of 15% at a temperature of 23° C., a 300% modulus of 515 kgf/cm², and a hardness of 73 degrees. The set linear pressure of the cleaning blade 11 was set to 1.80 g/mm which was in the range of 1.49 g/mm or more and 2.00 gf/mm or less.

A cleaning operation was performed up to the maximum number of uses prescribed in the image forming apparatus 100, using this cleaning device 115. As a result, it was possible to perform cleaning of the chemical toner with any problems.

In addition, each function which is described in the above embodiment may be configured using hardware, or may be realized by allowing a computer to read programs which describe each function, using software. In addition, each function may be a function which is configured by appropriately selecting either the software or the hardware.

Further, it is possible to realize each function by allowing the computer to read programs stored in a recording medium which is not shown. Here, the recording medium according to the embodiment of the invention may be a medium which can record programs and is a computer readable recording medium, and a recording format thereof is not limited to any format.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cleaning device which is used in an electrophotography-type image forming apparatus comprising:
a blade which removes toner remaining on a surface of a photoconductor,
a linear pressure of the blade with respect to the surface of the photoconductor and a value χ of rebound resilience of a material of the blade at a temperature of 23° C. satisfying a relationship shown in the expression below.
5.0×10⁻⁴×χ²−9.8×10⁻³×χ+1.52≦linear pressure≦2.0

2. The device according to claim 1,
wherein a value of 300% modulus of a material of the blade is 300 kgf/cm² or more.

3. The cleaning, device according to claim 2,
wherein the photoconductor is a photoconductive drum, and
wherein the cleaning device is provided on the downstream side of a developing device which develops a latent image by supplying toner to the photoconductive drum, in the rotation direction of the photoconductive drum.

4. The device according to claim 2,
wherein the toner is toner manufactured using a chemical method.

5. The device according to claim 2,
wherein an edge abrasion loss of the blade is 4 mm or less.

6. The device according to claim 2,
wherein a circularity of the toner is 0.95 or more and 0.97 or less,
wherein a value of rebound resilience at a temperature of 23° C. of a material of the blade is 15% or more, and
wherein a linear pressure of the blade is 1.5 g/mm or more.

7. An electrophotography-type image forming apparatus comprising:
a developing device which develops a latent image by providing toner to a photoconductor; and
a cleaning device which includes a blade which removes toner remaining on the surface of the photoconductor after the latent image is developed using the developing device,
a linear pressure of the blade with respect to the surface of the photoconductor and a value χ of rebound resilience of a material of the blade at a temperature of 23° C., satisfying a relationship shown in the expression below.
5.0×10⁻⁴×χ²−9.8×10⁻³×χ+1.52≦linear pressure≦2.0

8. The apparatus according to claim 7,
wherein a value of 300% modulus of a material of the blade is 300 kgf/cm² or more.

9. The apparatus according to claim 8,
wherein the photoconductor is a photoconductive drum, and
wherein the cleaning device is provided on the downstream side of the developing device in a rotation direction of the photoconductive drum.

10. The apparatus according to claim 8,
wherein the toner is toner manufactured using a chemical method.

11. The apparatus according to claim 8,
wherein an edge abrasion loss of the blade is 4 mm or less.

12. The apparatus according to claim 8,
wherein a circularity of the toner is 0.95 or more and 0.97 or less,
wherein a value of rebound resilience at a temperature of 23° C. of a material of the blade is 15% or more, and
wherein a linear pressure of the blade is 1.5 g/mm or more.

13. A cleaning method of a cleaning device which is used in an electrophotography-type image forming apparatus comprising:
providing a blade which removes toner remaining on a surface of a photoconductor, to a cleaning device,
setting a linear pressure of the blade with respect to the surface of the photoconductor and a value χ of rebound resilience of a material of the blade at a temperature of 23° C., to satisfy a relationship shown in the expression below.
5.0×10⁻⁴×χ²−9.8×10⁻³×χ+1.52≦linear pressure≦2.0

14. The method according to claim 13,
wherein a value of 300% modulus of a material of the blade is 300 kgf/cm² or more.

15. The method according to claim 14,
wherein the photoconductor is a photoconductive drum, and
wherein the cleaning device is provided on the downstream side of a developing device which develops a latent image by supplying toner to the photoconductive drum, in a rotation direction of the photoconductive drum.

16. The method according to claim 14,
wherein the toner is toner manufactured using a chemical method.

17. The method according to claim 14,
wherein an edge abrasion loss of the blade is 4 mm or less.

18. The method according to claim 14,
wherein a circularity of the toner is 0.95 or more and 0.97 or less,
wherein a value of rebound resilience at a temperature of 23° C. of a material of the blade is 15% or more, and
wherein a linear pressure of the blade is 1.5 g/mm or more.
